(19) United States
(12) Patent Application Publication
(10) Pub. No.: US 2003/0101359 A1
(43) Pub. Date: May 29, 2003

(54) System and method for controlling invalid password attempts

(75) Inventors: Sean Edward Aschen, New Haven, CT (US); James R. Doran, New Milford, CT (US); Brian Paul Olore, Monroe, NY (US); Christine Lynn Quintero, Poughkeepsie, NY (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/998,389

(22) Filed: Nov. 29, 2001

(51) Int. Cl. G06F 11/30

(52) U.S. Cl. 713/201; 713/156

(57) ABSTRACT

A system and method for controlling invalid password attempts in a multiple replica computer system environment is presented. A centralized strikeout server receives failed login attempts from the multiple replica servers over a secure sockets layer (SSL) connection. The centralized strikeout server tracks the number of failed login attempts over a configurable login tracking period. If the number of failed login attempts exceeds the number of failed login attempts allowed, the centralized server revokes the password corresponding to the user id which exceeded the number of failed login attempts allowed. Password revocation message are sent to one or more login servers. Cleanup processing removes older failed login attempts that occurred outside the login tracking period. Digital signatures, or certificates, are used to authenticate computer systems to one another.

### BACKGROUND OF THE INVENTION

1. Technical Field

The present invention relates in general to a method and system for accurately assessing the number of invalid password attempts. More particularly, the present invention relates to a system and method for controlling invalid password attempts in a multiple replica server environment.

2. Description of the Related Art

Computer systems that receive high volumes of traffic may have multiple replica servers to provide a fast response time to clients. Replica servers allow a client to be directed to a server that is not at capacity from servicing other clients. In turn, the computer system services each client more efficiently.

While business servers need to have quick response time to customers, they also need to watch for malicious clients. Some malicious clients attempt to gain access to a computer system by password hacking. Malicious clients may use software programs to automatically send thousands of requests to a server attempting to guess the correct username and password for the computer system. The hacking software uses a very large list of words that are likely username and password combinations.

If and when the malicious client gains access to the computer system, the malicious user can post the user id and password on any number of password trading Web sites. Many of these Web sites are very popular and may result in many unauthorized individuals gaining access to the protected computer system. If the server running the protected computer system is not set up for the increased traffic brought about by the additions of unauthorized users, the large volume of requests can overwhelm the server and cause it to be extremely slow or even fail.

A challenge found with using multiple replica servers is the difficulty in accurately track the number of login attempts for each unique user id. Typically, each server individually tracks the number of times a user fails to log in correctly, and revokes the user's password if the user exceeds the number of allowed log in attempts. With a multiple replica server computer system, however, a user may be directed to a different server each time he attempts to log in, and an accurate count of total failed log in attempts is not achieved. Instead, in a multiple replica server computer system, the number of failed login attempts at each server are tracked, rather than the total number of login attempts made by a particular userid.

What is needed, therefore, is a way to accurately determine the number of failed login attempts for a unique user id in a multiple replica server computer system.

### SUMMARY

It has been discovered that an accurate count of failed login attempts can be determined by having a centralized server receive and monitor failed login attempts from multiple servers.

A client attempts to log on to a computer network. The computer network may be one that receives a high traffic volume and has multiple replica servers to handle the high traffic. The client may be routed to a different server each time he attempts to log in. If the client fails to log in correctly, a software component, or plug-in, is invoked in the server.

The plug-in formats a message that includes the unique user id, or distinguished name, corresponding to the failed log in attempt, along with a digital certificate. The server that received the failed login attempt establishes a Secure Sockets Layer (SSL) connection through a computer network, such as the Internet or LAN, with a strikeout server that is responsible for monitoring the total number of failed log in attempts in the computer system.

The strikeout server authenticates the digital certificate and timestamps the distinguished name corresponding to the failed login attempt. The distinguished name and corresponding timestamp are stored in internal memory or a non-volatile storage area, such as a computer hard drive.

The strikeout server is configured to allow a certain number of failed log in attempts over a configurable login tracking period, such as 24 hours. When the strikeout server receives a failed login attempt, the strikeout server determines the number of prior failed login attempts that are within the tracking period. If the number of failed attempts within the tracking period are greater than the number of allowed attempts, the system checks if the password corresponding to the distinguished name has been revoked. If the password has not been revoked, the system revokes the password corresponding to the distinguished name. The password may thereafter be reinstated through normal procedures, such as with an automated process or through system administrator intervention.

On a periodic basis, outdated failed login attempts stored in memory are removed from the database. Outdated failed login attempts are those attempts that occurred prior to the login tracking period. The frequency of the database clean up is configurable by the system administrator.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of a client attempting to log on to centralized Lightweight Directory Access Protocol (LDAP) directory and the LDAP server sending failed login information to a strikeout server in response to a failed login attempt;

FIG. 2 is a high-level flowchart showing the system processing a login session;

FIG. 3 is a flowchart showing the configuration of strikeout server parameters;

FIG. 4 is a flowchart showing the cleanup process for outdated failed login attempts;

FIG. 5 is a flowchart showing the analysis of failed login attempts;

FIG. 6 is a flowchart showing failed login's being processed and response thereto; and

FIG. 7 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

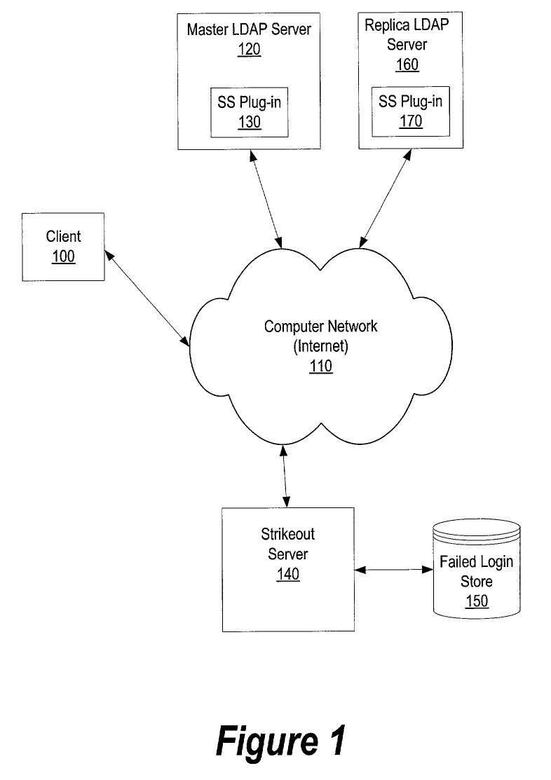

FIG. 1 is a diagram of a client attempting to log on to a centralized Lightweight Directory Access Protocol (LDAP) directory and the LDAP server sending failed login information to a strikeout server in response to a failed login attempt. Client 100 attempts to log on to master LDAP server 120 through computer network 110, such as the Internet. Strikeout server plug-in 130 is an LDAP Directory “Audit Plug-in”. Each time an operation transpires on LDAP server 120, strikeout server plug-in 130 is invoked.

Strikeout server plug-in 130 looks at the bind information presented by the client. It checks that the password supplied matches the password stored for the entry being used to bind with. If they do not match, the strikeout server plug-in 130 opens an SSL connection with strikeout server 140 through computer network 110, and sends the distinguished name (DN) of the entry that is used to attempt a bind. Strikeout server plug-in 130 sends a digital certificate along with the DN for authenticity. A distinguished name is an identifier that uniquely distinguishes a user, such as a user id, an employee number, or a commerce id.

Strikeout server 140 authenticates the certificate and timestamps the distinguished name corresponding to the failed login attempt. The distinguished name and corresponding timestamp are stored in failed login store 150. Failed login store 150 may be stored in internal memory or in a non-volatile storage area, such as a computer hard drive.

Multiple LDAP replicas may register failed login attempts. Client 100 may attempt to log on to different LDAP servers, such as replica LDAP server 160. Strikeout server plug-in 170 is an LDAP Directory “Audit Plug-in”. Each time an operation transpires on LDAP server 160, strikeout server plug-in 170 is invoked.

Strikeout server plug-in 170 looks at the bind information presented by the client. It checks that the password supplied matches the password stored for the entry being used to bind with. If they do not match, strikeout server plug-in 170 opens an SSL connection with Strikeout server 140 through computer network 110, and sends the distinguished name (DN) of the entry that is used to attempt a bind. Strikeout server plug-in 170 sends a digital certificate along with the DN for authenticity. A distinguished name is an identifier that uniquely distinguishes a user, such as a user id, an employee number, or a commerce id.

Strikeout server 140 tracks failed log in attempts throughout the computer system by distinguished name to achieve an accurate assessment of failed log in attempts by user id. When strikeout server 140 receives a failed login attempt corresponding to a distinguished name, strikeout server 140 determines if the number of failed login attempts for the corresponding distinguished name is greater than the number of failed login attempts allowed.

If the number of failed login attempts is greater than the number allowed, strikeout server 140 revokes the password corresponding to the distinguished name. Strikeout server 140 sends a message to Master LDAP server 120 that includes a message to revoke the password and set a password invalid flag to true for the corresponding distinguished name. Master LDAP server 120 revokes the appropriate password, sets the password invalid flag, and sends a message to replica LDAP server 160 to do the similar task in replica LDAP server 160's access list.

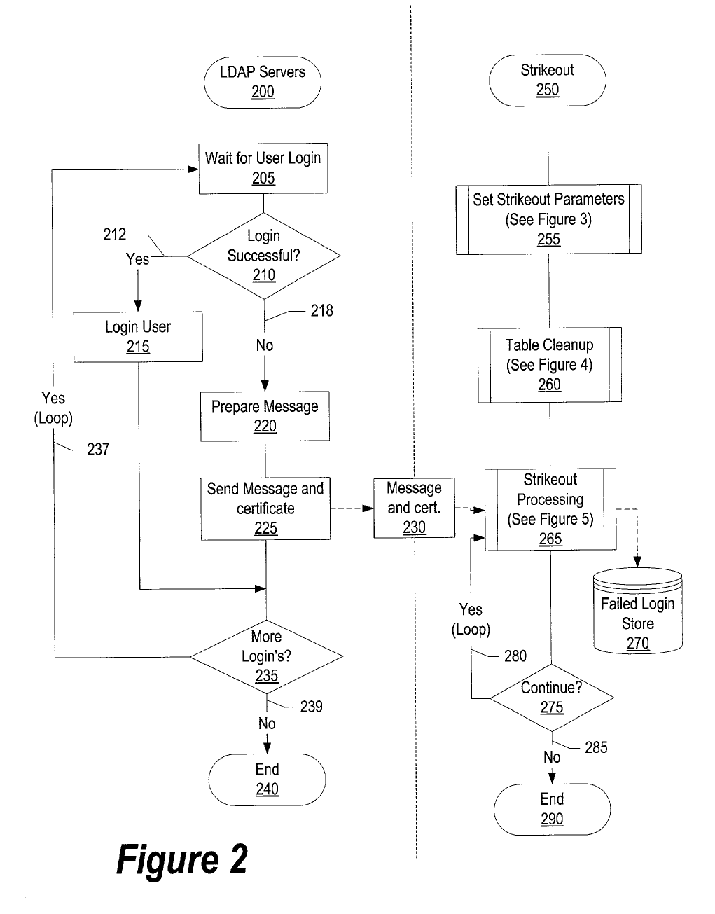

FIG. 2 is a high-level flowchart showing the system processing a login session. LDAP server processing commences at 200 whereupon processing waits for a user login at step 205. Once a user log's in, a determination is made as to whether the login was successful (decision 210). If the login was successful, decision 210 branches to “Yes” branch 212 whereupon the user is logged in (step 215), and processing bypasses failed login steps.

On the other hand, if the user login was not successful, decision 210 branches to “No” branch 218 whereupon a message is prepared which includes a distinguished name corresponding to the failed login and a digital certificate for authenticity (step 220). Message 230 is sent to a strikeout server at step 225 and a determination is made as to whether more login's should be waited for (decision 235).

If more login's are to be waited for, decision 235 branches to “Yes” branch 237 which loops back to wait for more login's. This looping continues until there are no more login's to be waited for, at which point decision 235 branches to “No” branch 239 and processing ends at 240.

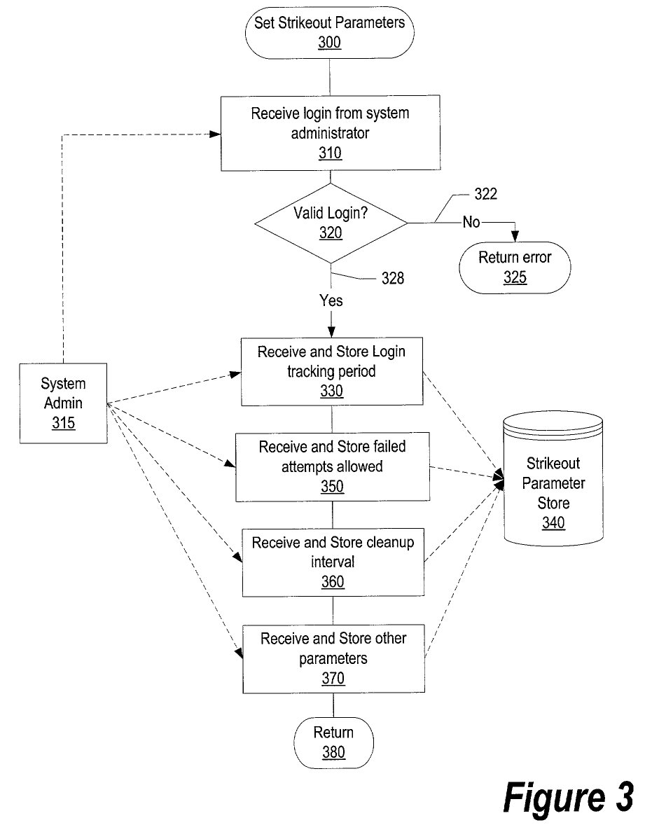

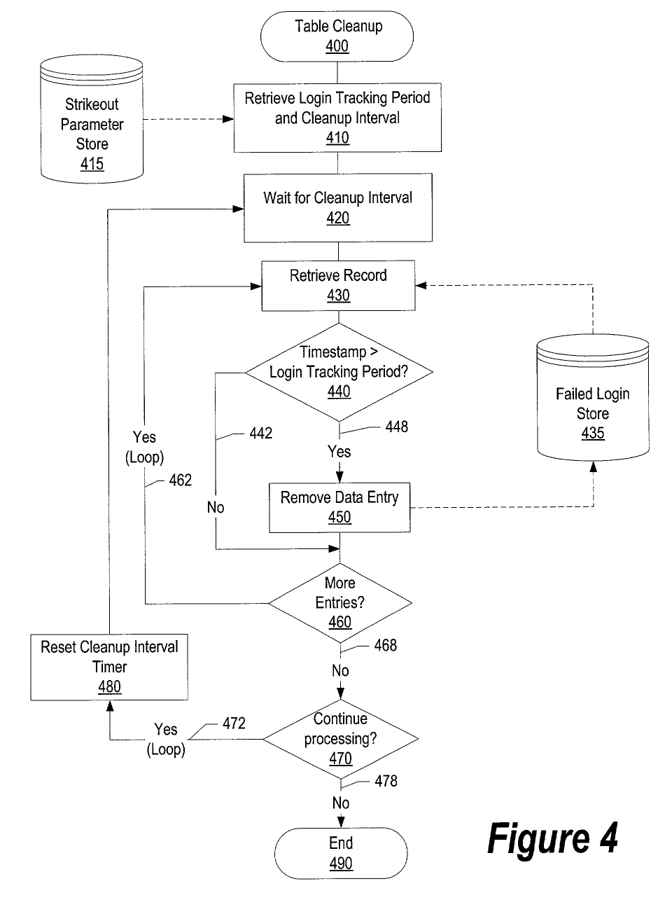

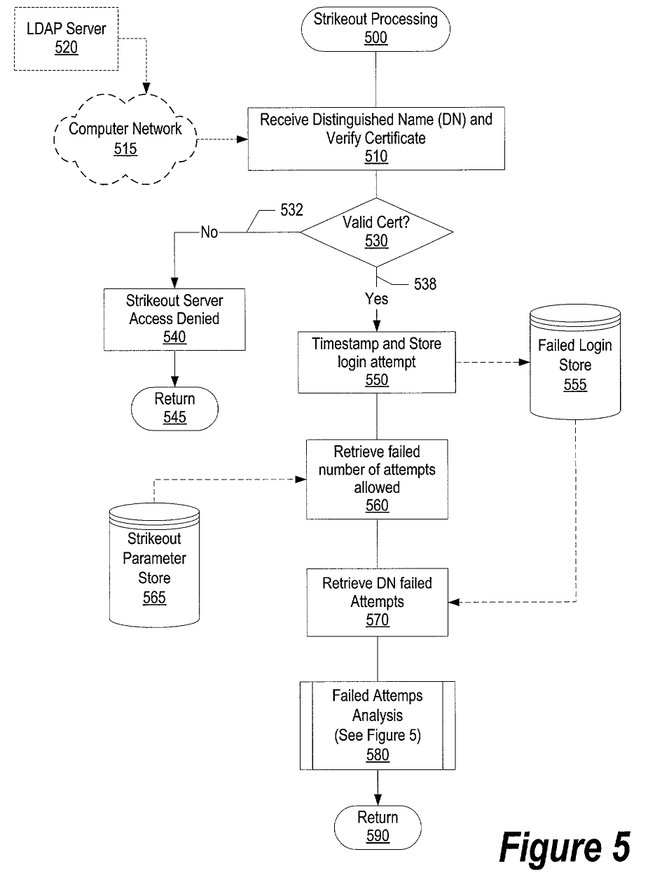

Strikeout server processing commences at 250, whereupon strikeout parameters are configured (pre-defined process block 255, see FIG. 3 for further details). Table cleanup processing initiates in background mode and runs simultaneously with strikeout server processing (predefined process block 260, see FIG. 4 for further details). Strikeout server process message 230 (predefined process block 265, see FIG. 5 for further details), and stores a resulting data record in failed login store 270. The data record includes a time stamped distinguished name corresponding to the failed login attempt. A determination is made as to whether strikeout processing should continue (decision 275). If processing is to continue, decision 275 branches to “Yes” branch 280 which loops back to process more messages. This looping continues until processing should not continue, at which point decision 275 branches to “No” branch 285 and strikeout processing ends at 290.

FIG. 3 is a flowchart showing the configuration of strikeout server parameters. Processing commences at 300, whereupon a login is received from system administrator 320 (step 310). A determination is made as to whether the login is valid (decision 320). If the login is not valid, decision 320 branches to “No” branch 322 whereupon an error is returned at 325. On the other hand, if the login is valid, decision 320 branches to “Yes” branch 328. In one embodiment, a system administrator may supply a digital certificate to provide a higher level of security in addition to login and password security.

After the successful login, a login tracking period is received from system administrator 315 and stored in strikeout parameter store 340 (step 330). Strikeout parameter store 340 may be stored in a non-volatile storage area, such as a computer hard drive. Login tracking period describes the time interval that processing tracks the number of failed login attempts. For example, login tracking period may be configured for twenty-four hours so processing tracks the number of failed login attempts in a twenty four hour period.

A number of allowed failed login attempts are received from system administrator 315 and stored in strikeout parameter store 340 (step 350). The number of allowed failed attempts are the number of failed login attempts that processing allows for a specific user id, or distinguished name, before processing revokes the password corresponding to the userid.

A cleanup interval is received from system administrator 315 and stored in strikeout parameter store 340 (step 360). The cleanup interval is the time interval that processing reviews the stored failed log in attempts and removes the failed log in attempts that occurred outside the login tracking period. For example, the cleanup interval may be configured for five-minute intervals. Using the example above, every five minutes processing reviews the stored failed login attempts and removes those attempts that occurred longer than twenty-four hours from the review time.

Other parameters are received from system administrator 315 and stored in strikeout parameter store 340 (step 370). For example, other parameters may include a list of user id's that have higher-level security access. System administrator 315 may require a lower threshold of failed login attempts for those individuals, such as three attempts, before their password is set to null. Processing returns at 380.

FIG. 4 is a flowchart showing a cleanup process for outdated failed login attempts. Processing commences at 400, whereupon the login tracking period and cleanup interval are retrieved from strikeout parameter store 415 (step 410). The cleanup interval timer starts and processing waits for the timer to expire (step 420). A failed login attempt data record is retrieved from failed login store 435 (step 430). A determination is made as to whether the data record's timestamp is later in time than the login tracking period (decision 440). If the timestamp is within the login tracking period, decision 440 branches to “No” branch 442, bypassing step 450.

On the other hand, if the timestamp is outside the login tracking period, decision 440 branches to “Yes” branch 448 whereupon the data entry is removed from failed login store 435 (step 450). For example, if the review time is 12:45PM and the login tracking period is twenty four hours, the data entry is removed if the timestamp is earlier than 12:45PM on the previous day.

A determination is made as to whether there are more data entries in failed login store 435 for analysis (decision 460). If there are more records, decision 460 branches to “Yes” branch 462 which loops back to retrieve the next record. This looping continues until there are no more records to analyze, at which point decision 460 branches to “No” branch 468. A determination is made as to whether processing continues (decision 470). If table cleanup processing should continue, decision 470 branches to “Yes” branch 472 which resets the clean up interval timer (step 480) and loops back to wait for the timer to expire. On the other hand, if processing should not continue, decision 470 branches to “No” branch 478 and processing ends at 490.

FIG. 5 is a flowchart showing the analysis of number of failed login attempts and setting passwords to null. Processing commences at 500, whereupon a distinguished name corresponding to a failed user login attempt and a digital certificate are received from LDAP server 520 through computer network 515 (step 510). The LDAP server's digital certificate is validated to ensure the authenticity of the information (decision 530). If the certificate is not valid, decision 520 branches to “No” branch 532 whereupon access is denied to the strikeout server (step 540) and processing returns at 545.

On the other hand, if the certificate is valid, decision 530 branches to “yes” branch 538 whereupon the distinguished name is time stamped and stored in failed login store 555 (step 550). The distinguished name and timestamp information are stored in the same data record. The number of allowed failed login attempts are retrieved from strikeout parameter store 565 (step 560).

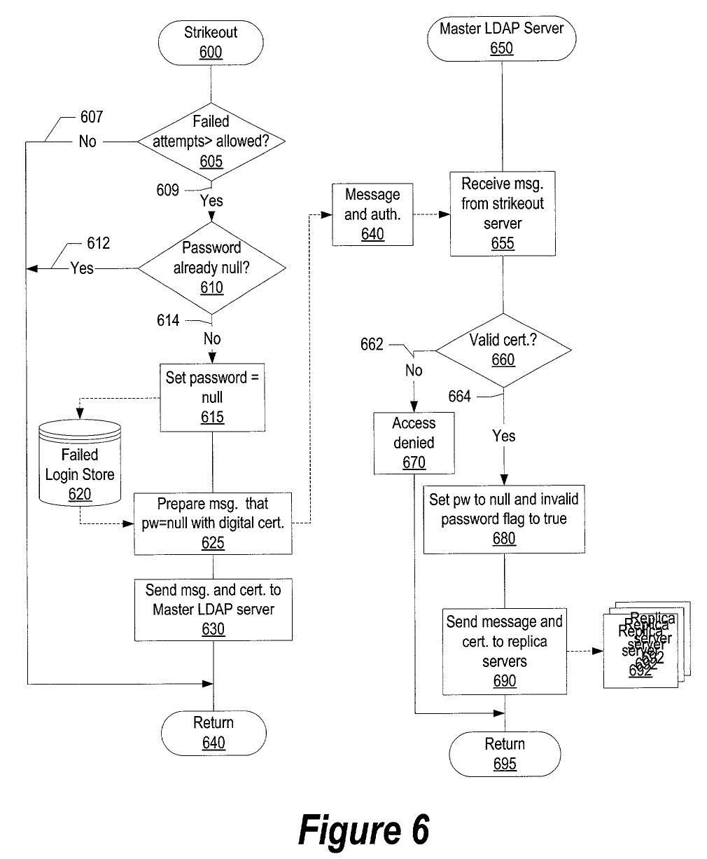

The number of failed login attempts, including the most recent occurrence, corresponding to the distinguished name is retrieved from failed login store 555 (step 570). Failed login analysis is processed (pre-defined process block 580, see FIG. 6 for further details), and processing returns at 590.

FIG. 6 is a flowchart showing failed login's being processed and response thereto. Strikeout processing commences at 600, whereupon a determination is made as to whether the number of failed attempts is greater than the number of failed attempts allowed (decision 605). If the number of attempts is less than or equal to the number of attempts allowed, decision 605 branches to “No” branch 607, bypassing the password analysis. On the other hand, if the number of failed attempts is greater than the number of attempts allowed, decision 605 branches to “Yes” branch 609.

A determination is made as to whether the password is already null (decision 610) by checking a password is struck out flag. For example, the user may have exceeded the number of allowed attempts recently and his password was revoked. The user, however, may still be attempting to log in. If the password is already set to null, decision 610 branches to “Yes” branch 612, bypassing password invalidation steps. On the other hand, if the password has not been previously been revoked, decision 610 branches to “No” branch 614. The password is set to null and the password invalid flag is set to true (step 615).

A message is prepared which includes information to revoke the password and set a password invalid flag to true for the corresponding distinguished name (step 625). The message is sent (message 640) to the master LDAP server at step 630.

Master LDAP processing commences at 650, whereupon message 640 is received from the strikeout server (step 655). A determination is made as to whether the authorization is valid (decision 660). Authorization may be in the form of a user id and password combination, or a digital certificate. If the authorization is not valid, decision 660 branches to “No” branch 662 whereupon access is denied (step 670) and processing returns at 695.

On the other hand, if the authorization is valid, decision 660 branches to “Yes” branch 664 which sets the password to null and the password invalid flag to true for the corresponding distinguished name (step 680). A message is prepared and sent to replica servers 692 to revoke the password and set the password invalid flag to true for the corresponding distinguished name (step 690). Master LDAP processing returns at 695.

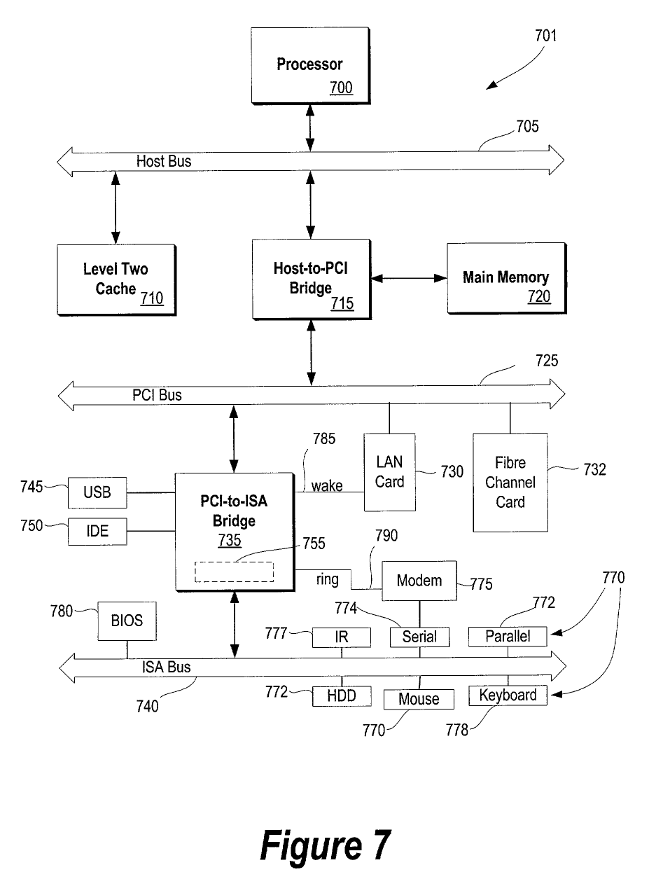

FIG. 7 illustrates information handling system 701 which is a simplified example of a computer system capable of performing the server and client operations described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (HDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 to another computer system to copy files over a network, LAN card 730 is coupled to PCI bus 725 and to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “a” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of managing invalid password attempts, said method comprising:
receiving a message from a computer system, wherein the message includes a distinguished name, the distinguished name corresponding to a failed login attempt;
calculating a total failed login attempt number corresponding to the distinguished name;
identifying a failed login attempt allowed number;
determining whether the total failed login attempt number is greater than the failed login attempt allowed number; and
revoking a password corresponding to the distinguished name based on the determination.

2. The method as described in claim 1 wherein the message is received from a plurality of servers.

3. The method as described in claim 1 further comprising:
establishing a secure connection with the computer system; and
verifying a digital certificate corresponding to the computer system, wherein the digital certificate is included in the message.

4. The method as described in claim 1 wherein the determining further comprises:
configuring parameters, wherein the parameters include a login tracking period;
storing a record in a failed login data store, the record including the distinguished name and a timestamp corresponding to a time the message was received; and
removing one or more records from the failed login data store in response to one or more corresponding timestamps being older than the tracking period.

5. The method as described in claim 1 wherein the revoking further includes:
preparing a password revocation message, the password revocation message identifying the distinguished name; and
sending the password revocation message to one or more login servers, wherein the login servers include the computer system.

6. The method as described in claim 5 further comprising:
establishing a secure connection to each of the login servers; and
including a digital signature identifying a sending computer system in the password revocation message.

7. The method as described in claim 5 wherein the password revocation message is sent in response to determining that the password was not previously revoked; and
wherein the password revocation message is not sent in response to determining that the password was previously revoked.

8. An information handling system comprising:
one or more processors;
a memory accessible by the processors;
one or more nonvolatile storage devices accessible by the processors;
a password managing tool to process invalid password attempts, the password managing tool including:
means for receiving a message from a computer system, wherein the message includes a distinguished name, the distinguished name corresponding to a failed login attempt;
means for calculating a total failed login attempt number corresponding to the distinguished name;
means for identifying a failed login attempt allowed number;
means for determining whether the total failed login attempt number is greater than the failed login attempt allowed number; and
means for revoking a password corresponding to the distinguished name based on the determination.

9. The information handling system as described in claim 8 wherein the message is received from a plurality of servers.

10. The information handling system as described in claim 8 further comprising:
means for establishing a secure connection with the computer system; and
means for verifying a digital certificate corresponding to the computer system, wherein the digital certificate is included in the message.

11. The information handling system as described in claim 8 wherein the determining further comprises:
means for configuring parameters, wherein the parameters include a login tracking period;
means for storing a record in a failed login data store, the record including the distinguished name and a timestamp corresponding to a time the message was received; and
means for removing one or more records from the failed login data store in response to one or more corresponding timestamps being older than the tracking period.

12. The information handling system as described in claim 8 wherein the revoking further includes:
means for preparing a password revocation message, the password revocation message identifying the distinguished name; and
means for sending the password revocation message to one or more login servers, wherein the login servers include the computer system.

13. The information handling system as described in claim 12 further comprising:
means for establishing a secure connection to each of the login servers; and
means for including a digital signature identifying a sending computer system in the password revocation message.

14. A computer program product stored in a computer operable media for processing invalid password attempts, said computer program product comprising:
means for receiving a message from a computer system, wherein the message includes a distinguished name, the distinguished name corresponding to a failed login attempt;
means for calculating a total failed login attempt number corresponding to the distinguished name;
means for identifying a failed login attempt allowed number;
means for determining whether the total failed login attempt number is greater than the failed login attempt allowed number; and
means for revoking a password corresponding to the distinguished name based on the determination.

15. The computer program product as described in claim 14 wherein the message is received from a plurality of servers.

16. The computer program product as described in claim 14 further comprising:
means for establishing a secure connection with the computer system; and
means for verifying a digital certificate corresponding to the computer system, wherein the digital certificate is included in the message.

17. The computer program product as described in claim 14 wherein the determining further comprises:
means for configuring parameters, wherein the parameters include a login tracking period;
means for storing a record in a failed login data store, the record including the distinguished name and a timestamp corresponding to a time the message was received; and
means for removing one or more records from the failed login data store in response to one or more corresponding timestamps being older than the tracking period.

18. The computer program product as described in claim 14 wherein the revoking further includes:
means for preparing a password revocation message, the password revocation message identifying the distinguished name; and
means for sending the password revocation message to one or more login servers, wherein the login servers include the computer system.

19. The computer program product as described in claim 18 further comprising:
means for establishing a secure connection to each of the login servers; and
means for including a digital signature identifying a sending computer system in the password revocation message.

20. The computer program product as described in claim 18 wherein the password revocation message is sent in response to determining that the password was not previously revoked; and
wherein the password revocation message is not sent in response to determining that the password was previously revoked.
